(19) United States
(12) Patent Application Publication
(10) Pub. No.: US 2022/0201811 A1
(43) Pub. Date: Jun. 23, 2022

(54) COIL FOR INDUCTION HEATING, METHOD FOR MANUFACTURING THE SAME, AND METHOD FOR MANUFACTURING QUENCHED PRODUCT

(71) Applicant: TOYOTA JIDOSHA KABUSHIKI KAISHA, Toyota-shi (JP)

(72) Inventor: Yasuhiro ENOMOTO, Toyota-shi (JP)

(73) Assignee: TOYOTA JIDOSHA KABUSHIKI KAISHA, Toyota-shi, Aichi-ken (JP)

(21) Appl. No.: 17/517,270

(22) Filed: Nov. 2, 2021

(30) Foreign Application Priority Data
Dec. 23, 2020 (JP) 2020-213642

(51) Int. Cl. H05B 6/36; B29C 65/36

(52) U.S. Cl. CPC H05B 6/365; B29C 65/3676

(57) ABSTRACT

A coil for induction heating comprising a conductor wire. The conductor wire includes a base layer that is disposed on a center side of the conductor wire and an additional layer that is joined to an outer periphery of the base layer. The additional layer is biased toward the inner periphery side of the coil than the other sides of the coil. A metallic element which is the main component of a material of the additional layer differs from a metallic element which is the main component of a material of the base layer. The electrical resistivity of the added layer is lower than the electrical resistivity of the base layer.

### CROSS REFERENCE TO RELATED APPLICATIONS

This application is based upon and claims the benefit of priority from Japanese patent application No. 2020-213642, filed on Dec. 23, 2020, the disclosure of which is incorporated herein in its entirety by reference.

### BACKGROUND

The present disclosure relates to a coil for induction heating, a method for manufacturing the coil, and a method for manufacturing a quenched product.

Japanese Unexamined Patent Application Publication No. 2009-043503 discloses a coil for induction heating. An outer peripheral surface of the coil faces the inner peripheral surface of an object-to-be-processed. The outer periphery and the inner periphery of the coil are made of a copper-aluminum alloy. Since the outer periphery of the coil is oxidized, the electric conductivity is higher in the outer periphery of the coil than that in the inner periphery of the coil. Published Japanese Translation of PCT International Publication for Patent Application, No. 2020-527279 discloses that a surface layer is formed by bonding a material different from the material of the base layer, such as a silver-palladium alloy, on a base layer of a coil for induction heating.

### SUMMARY

Generation of the Joule heat from a conductor wire of a coil for induction heating is suppressed.

<1> A coil for induction heating including a conductor wire that includes a base layer that is disposed on a center side of the conductor wire and an additional layer that is joined to an outer periphery of the base layer, in which

the additional layer is biased toward a coil inner periphery side of the conductor wire than the other sides of the conductor wire,

a metallic element which is the main component of a material of the additional layer differs from a metallic element which is the main component of a material of the base layer, and

the electrical resistivity of the added layer is lower than the electrical resistivity of the base layer.

<2> The coil for induction heating, in which

the metallic element which is the main component of the material of the additional layer is silver, and

the material of the base layer is copper having purity of 99.9% or higher.

<3> The coil for induction heating, in which

the conductor wire is a conductor tube including a flow channel at the center thereof,

the base layer is formed into a tubular shape so as to surround the flow channel,

the thickness of the conductor tube on the coil inner periphery side is larger than the thickness of the conductor tube on the coil outer periphery side, and

the thickness of the base layer on the coil inner periphery side does not exceed the thickness of the base layer on the coil outer periphery side.

<4> The coil for induction heating in which the additional layer and the base layer are joined to each other by a layer in which the material of the additional layer and the material of the base layer are mixed.

<5> A method for manufacturing the coil for induction heating, including

laminating the material of the additional layer by cladding on the coil inner periphery side of the base layer made of the material of the base layer.

<6> The method for manufacturing the coil for induction heating, in which

the coil including the base layer made of the material is configured of a conductor tube including a flow channel at the center thereof, and

the coil configured of the conductor tube is formed by additive manufacturing before the material of the additional layer is laminated.

<7> A method for manufacturing a quenched product including:

inserting a work inside the coil for induction heating;

causing an alternate current to flow through the coil for induction heating; and

hardening the work by induction heating the work.

<8> A coil for induction heating including a conductor wire that includes a base layer that is disposed on a center side of the conductor wire and an additional layer that is joined to an outer periphery of the base layer, in which

the additional layer is biased toward a coil outer periphery side of the conductor wire than the other sides of the conductor wire,

a metallic element which is the main component of a material of the additional layer differs from a metallic element which is the main component of a material of the base layer, and

the electrical resistivity of the added layer is lower than the electrical resistivity of the base layer.

Generation of the Joule heat from a conductor wire of a coil for induction heating is suppressed.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective diagram of a coil;

FIG. 2 is a cross-sectional diagram of a conductor wire of the coil;

FIG. 3 is a side view of the coil;

FIG. 4 is a cross-sectional diagram of a conductor tube;

FIG. 5 is a cross-sectional diagram of a conductor tube; and

FIG. 6 is a cross-sectional diagram of a conductor tube.

### DESCRIPTION OF EMBODIMENTS

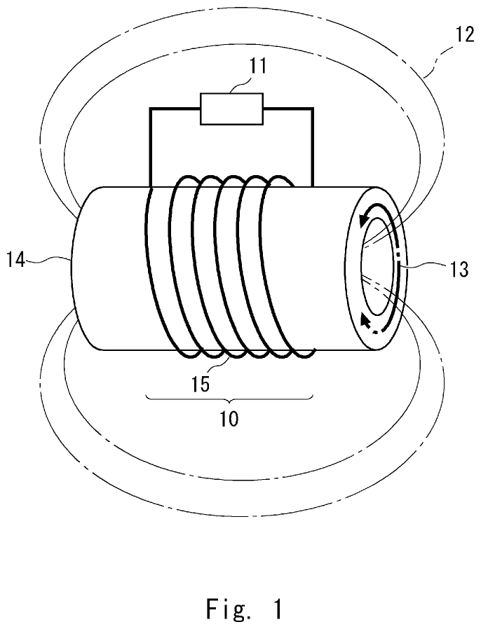

FIG. 1 is a perspective diagram of a coil 10. The coil 10 is a coil for induction heating formed of a conductor wire 15. The coil 10 is generally used as described below. A workpiece 14 made of metal is inserted into the coil 10. An alternating current of high frequency is applied from a power source 11 to the coil 10. The coil 10 generates a magnetic field 12. The magnetic field 12 generates an eddy current 13 in the workpiece 14. The eddy current 13 generates the Joule heat in the workpiece 14. As described above, the workpiece 14 is quenched by induction heating the workpiece 14. Accordingly, a quenched product is manufactured from the workpiece 14.

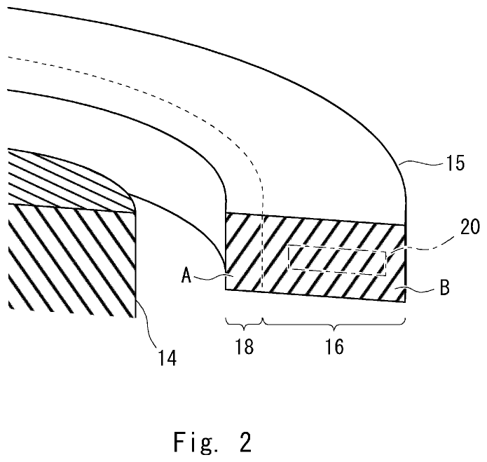

FIG. 2 is a cross-sectional diagram of the conductor wire 15. The conductor wire 15 includes a base layer 16 disposed on the center side thereof. The conductor wire 15 further includes an additional layer 18. The additional layer 18 is joined to the outer periphery of the base layer 16. Note that the “outer periphery” of the base layer 16 refers to an entire peripheral edge part of the base layer 16, that is, a part surrounding the center of the base layer 16. The same definition is applied for the “outer periphery” of the conductor wire 15. The “outer periphery” of the conductor wire 15 is distinguished from the “outer periphery” of the coil 10 illustrated in FIG. 1. The “outer periphery” of the conductor wire 15 appears on both the inner periphery side and the outer periphery side of the coil 10 illustrated in FIG. 1. Hereinbelow, the inner periphery side of the coil 10 is also referred to as the coil inner periphery side. Further, the outer periphery side of the coil 10 is also referred to as the coil outer periphery side.

In one aspect shown in FIG. 2, the metallic element which is the main component of a material B of the base layer 16 is copper. In the aforementioned aspect, the material of the base layer 16 is copper with a purity equal to or higher than 99.0%. In the aforementioned aspect, the purity of copper is any one of 99.1%, 99.2%, 99.3%, 99.4%, 99.5%, 99.6%, 99.7%, 99.8%, or 99.9%. In the aforementioned aspect, the purity of copper is any one of 99.90%, 99.91%, 99.92%, 99.93%, 99.94%, 99.95%, 99.96%, 99.97%, 99.98%, or 99.99%. In the aforementioned aspect, the material of the base layer 16 is any one of oxygen-free copper, tough pitch copper, or phosphorus deoxidized copper.

The metallic element which is the main component of a material A of the additional layer 18 shown in FIG. 2 differs from the metallic element which is the main component of the material of the base layer 16. Therefore, the electrical resistivity of the additional layer 18 is lower than that of the base layer 16. In the aforementioned aspect, the metallic element which is the main component of the material of the additional layer 18 is silver. In the aforementioned aspect, the material of the additional layer 18 is silver with a purity equal to or higher than 99.0%. In the aforementioned aspect, the purity of silver is any one of 99.1%, 99.2%, 99.3%, 99.4%, 99.5%, 99.6%, 99.7%, 99.8%, or 99.9%. In the aforementioned aspect, the purity of silver is any one of 99.90%, 99.91%, 99.92%, 99.93%, 99.94%, 99.95%, 99.96%, 99.97%, 99.98%, or 99.99%.

In one aspect shown in FIG. 2, a flow channel 20 is formed by hollowing out the center of the conductor wire 15. Details thereof will be described later.

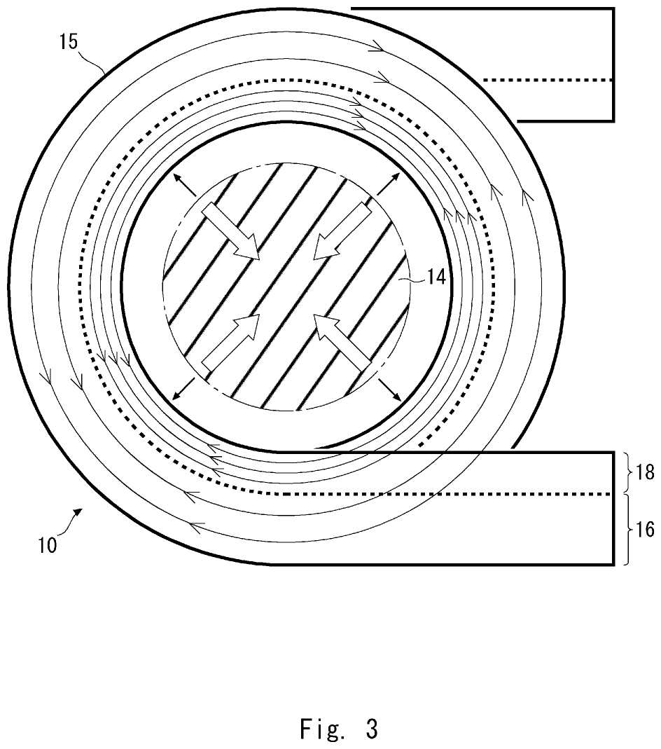

FIG. 3 is a side view of the coil 10. Only the workpiece 14 is shown in cross-section. As described earlier, the workpiece 14 is induction heated. Specifically, the Joule heat is generated on the surface of the workpiece 14. The heat conducts toward the inside of the workpiece 14. Further, the heat radiates toward the surrounding of the workpiece 14.

As shown in FIG. 3, the additional layer 18 is biased toward the coil inner periphery side of the conductor wire 15 than the other sides of the conductor wire. In one aspect, at any part of the coil 10, the additional layer 18 is closer to the surface of the work 14 than the base layer 16 is.

Person skilled in the art understands that, when the path of electricity is taken into account, the path of the conductor wire is shorter on the coil inner periphery side than that on the coil outer periphery side. The electrical resistivity of the coil inner periphery side of the conductor wire is smaller than the electrical resistivity of the coil outer periphery side of the conductor wire. In cross-section of the coil conductor wire, the current density of the coil inner periphery side of the conductor wire is larger than the current density of the coil outer periphery side of the coil. Therefore, the current density of the additional layer 18 shown in FIG. 3 is higher than the current density of the base layer 16.

Further, as described above, the electrical resistivity of the additional layer 18 shown in FIG. 3 is lower than that of the base layer 16. Therefore, the current density of the additional layer 18 further increases. Accordingly, current crowding occurs on the inner periphery side of the coil 10. Therefore, intensive induction heating is performed on the workpiece 14.

In FIG. 3, when the level of the induction heating energy applied to the workpiece 14 is to be maintained, a large amount of current flows through the additional layer 18, whereby the amount of current that flows through the base layer 16 having a relatively high electrical resistivity decreases. Therefore, the amount of electric power lost as the Joule heat in the whole coil 10 is small.

In one aspect shown in FIG. 2, the conductor wire 15 is formed of a conductor tube that includes the flow channel 20 at the center thereof. Coolant that flows through the flow channel 20 adsorbs the Joule heat generated inside the conductor wire 15. In one aspect, the coolant is water. In other aspects, the conductor wire 15 does not include the flow channel 20 or any other hollow part at the center thereof. The conductor wire 15 that includes the flow channel 20 is formed as described below.

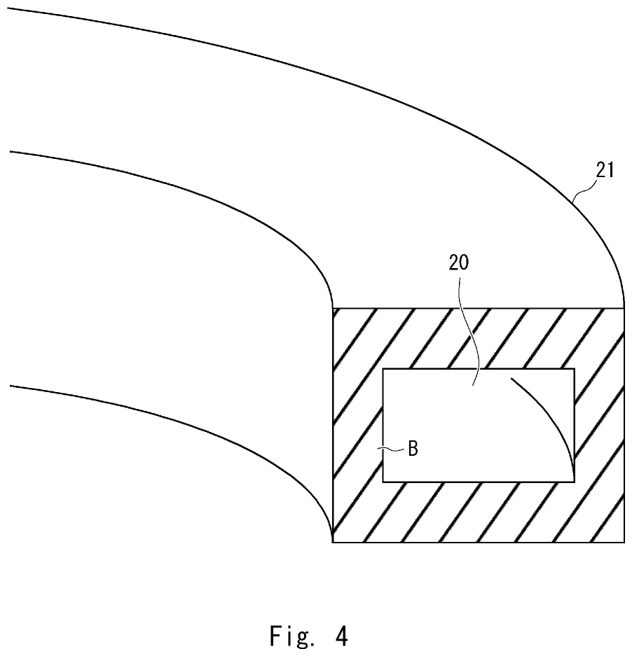

FIG. 4 shows a cross-section of the conductor tube 21 made of the material B. The material B is shaped into a tube so as to surround the hollow serving as the flow channel 20. The obtained conductor tube 21 includes the flow channel 20 at the center thereof. The conductor tube 21 serves as the base layer 16 shown in FIG. 2. FIG. 2 shows the state in which the added layer is laminated on the base layer made of the material B.

The conductor tube 21 shown in FIG. 4 configures the coil. In one aspect, a coil formed of the conductor tube 21 is manufactured by laminated modeling. In the aforementioned aspect, laminated modeling is performed using a 3D printer.

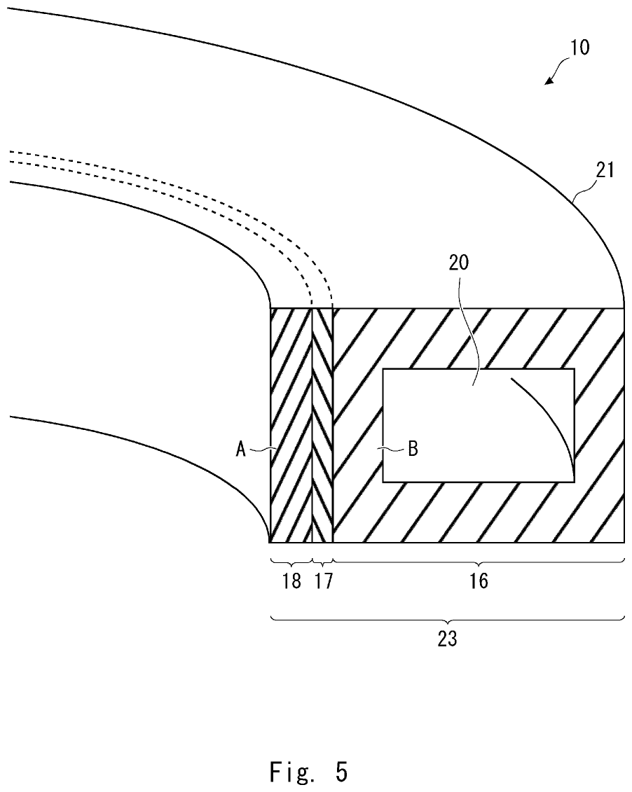

FIG. 5 shows a cross-section of a conductor tube 23 made of the material B and the material A. The conductor tube 23 serves as a conductor wire for a coil for heat induction. By laminating the material B on the outer periphery of the conductor tube 21, the conductor tube 23 shown in FIG. 5 is formed. The lamination of the material B is biased toward the coil inner periphery side of the conductor tube 21 than the other sides of the conductor tube 21. In one aspect, laminating is performed by cladding. Since the space around the coil inner periphery side is smaller than the space around the coil outer periphery side, operation of a laser cladding apparatus is limited. It is, therefore, desirable to perform cladding by, for instance, a laser deposition method which is a directional energy deposition method.

As shown in FIG. 5, the conductor tube 23 includes an intermediate layer 17 between the base layer 16 and the additional layer 18. In the intermediate layer 17, the material A of the additional layer 18 and the material B of the base layer 16 are mixed. The intermediate layer 17 joins the additional layer 18 and the base layer 16 to each other.

In FIG. 5, the thickness of the conductor tube 23 on inner periphery side of the coil including the thickness of the additional layer 18 is larger than the thickness of the conductor tube 23 on the outer periphery side of the coil. In one aspect, the thickness of the conductor tube 21 formed of the base layer 16 on the coil inner periphery side does not exceed the thickness of the conductor tube 21 formed of the base layer 16 on the coil outer periphery side. In another aspect, the thickness of the conductor tube 21 formed of the base layer 16 on the coil inner periphery side is equal to the thickness of the conductor tube 21 formed of the base layer 16 on the coil outer periphery side.

In FIG. 5, the amount of the conductor material of the inner periphery side of the coil is larger than the amount of the conductor material of the outer periphery side of the coil due to the additional layer 18 provided to the coil. Therefore, further current concentration occurs in the coil on the coil inner periphery side. Accordingly, a stronger induction heating is applied to the workpiece 14. Further, when a high level of induction heating energy is maintained, less current flows through the coil outer periphery side of the coil where the electrical resistivity is high. Therefore, the amount of electric power lost as the Joule heat across the whole coil 10 is small.

Note that the present disclosure is not limited to the aforementioned embodiments and can be changed as appropriate without departing from the gist of the present disclosure.

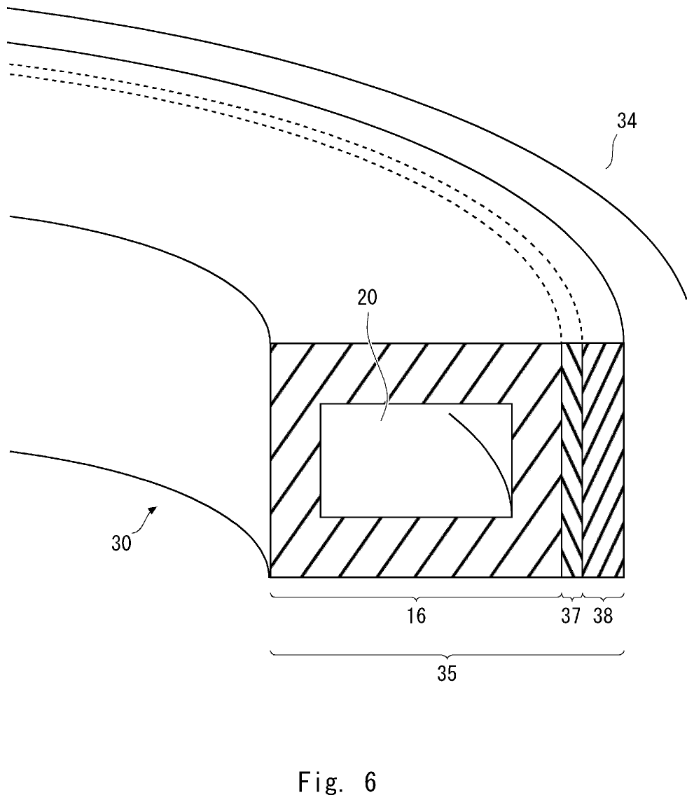

FIG. 6 shows a cross-section of a conductor wire 35 that constitutes a coil 30 for induction heating according to another embodiment. The conductor wire 35 includes the base layer 16 and the additional layer 38. The additional layer 38 is joined to the outer periphery of the base layer 16. The additional layer 38 is biased toward the outer periphery side in the coil 30 of the conductor wire 35 than the other sides of the of the conductor wire 35. The material of the additional layer 38 is the same as the material A for the additional layer 18 shown in FIG. 2. The electrical resistivity of the additional layer 38 is lower than that of the base layer 16. In the aforementioned aspect, the additional layer 38 and the base layer 16 are joined to each other by an intermediate layer 37 in which the material of the added layer 38 and the material of the base layer 16 are mixed. As regards the other points, the coil 30 is manufactured in the same way as each of the coils 10 shown in FIGS. 2 and 5 is manufactured.

In an aspect shown in FIG. 6, the workpiece 34 is induction heated by the coil 30. The workpiece 34 includes a cavity. Induction heating is performed by inserting the coil 30 into the cavity of the workpiece 34. The additional layer 38 opposes the inner peripheral surface of the workpiece 34.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A coil for induction heating comprising a conductor wire that includes a base layer that is disposed on a center side of the conductor wire and an additional layer that is joined to an outer periphery of the base layer, wherein
the additional layer is biased toward the coil inner periphery side of the conductor wire than the other sides of the conductor wire,
a metallic element which is the main component of a material of the additional layer differs from a metallic element which is the main component of a material of the base layer, and
the electrical resistivity of the added layer is lower than the electrical resistivity of the base layer.

2. The coil for induction heating according to claim 1, wherein
the metallic element which is the main component of the material of the additional layer is silver, and
the material of the base layer is copper having purity of 99.9% or higher.

3. The coil for induction heating according to claim 1, wherein
the conductor wire is a conductor tube including a flow channel at the center thereof,
the base layer is formed into a tubular shape so as to surround the flow channel,
the thickness of the conductor tube on the coil inner periphery side is larger than the thickness of the conductor tube on the coil outer periphery side, and
the thickness of the base layer on the coil inner periphery side does not exceed the thickness of the base layer on the coil outer periphery side.

4. The coil for induction heating according to claim 1, wherein the additional layer and the base layer are joined to each other by a layer in which the material of the additional layer and the material of the base layer are mixed.

5. A method for manufacturing the coil for induction heating according to claim 1, comprising
laminating the material of the additional layer by cladding on the coil inner periphery side of the base layer made of the material of the base layer.

6. The method for manufacturing the coil for induction heating according to claim 5, wherein
the coil including the base layer made of the material is configured of a conductor tube including a flow channel at the center thereof, and
the coil configured of the conductor tube is formed by additive manufacturing before the material of the additional layer is laminated.

7. A method for manufacturing a quenched product comprising:
inserting a work inside the coil for induction heating according to claim 1;
causing an alternate current to flow through the coil for induction heating; and
hardening the work by induction heating the work.

8. A coil for induction heating comprising a conductor wire that includes a base layer that is disposed on a center side of the conductor wire and an additional layer that is joined to an outer periphery of the base layer, wherein
the additional layer is biased toward the outer periphery side of the coil than the other sides of the coil,
a metallic element which is the main component of a material of the additional layer differs from a metallic element which is the main component of a material of the base layer, and
the electrical resistivity of the added layer is lower than the electrical resistivity of the base layer.
